(19) United States
(12) Patent Application Publication
(10) Pub. No.: US 2022/0357195 A1
(43) Pub. Date: Nov. 10, 2022

(54) LONG-DISTANCE HIGH-PRECISION OPTICAL FIBER INTERFERENCE SENSING AND POSITIONING SYSTEM

(71) Applicant: GUANGDONG FUAN SCIENCE & TECHNOLOGY DEVELOPMENT CO., LTD., Dongguan (CN)

(72) Inventors: Chao WANG, Dongguan (CN); Bo JIA, Dongguan (CN)

(21) Appl. No.: 17/622,186

(22) PCT Filed: Aug. 19, 2019
(86) PCT No.: PCT/CN2019/101424

§ 371 Date: Dec. 22, 2021

(30) Foreign Application Priority Data
Jul. 25, 2019 (CN) 201910676620.X
Jul. 25, 2019 (CN) 201921189688.7

(51) Int. Cl. G01H 9/00; H04B 10/079; H04B 10/25

(52) U.S. Cl. CPC G01H 9/004; H04B 10/0795; H04B 10/25891

(57) ABSTRACT

A long-distance high-precision optical fiber interference sensing and positioning system includes a sensing light path, a control terminal, a light source module, a front-end optical processing module, a back-end optical processing module, a photoelectric conversion module, a digital signal collection module and a MCU central processing module. The control terminal is provided with a signal processing and positioning device for calculating and positioning sensing signal positioning information. The present system can solve the security problem of an ultra-long-distance optical cable, can send alarm information in a timely manner with regard to an intrusion event by means of vibration positioning, and can also solve the problem of occupation of an optical cable channel, and improves the utilization efficiency of the optical cable by means of wavelength division multiplexing technology.

### FIELD OF THE INVENTION

The present invention relates to the field of communication technologies, and more particularly to a long-distance high-precision optical fiber interference sensing and positioning system.

### BACKGROUND OF THE INVENTION

With the rapid development of the communication industry in the world, the security of communication optical fiber cables has attracted more and more attention, especially the security of ultra-long-distance optical fiber cables, such as submarine optical fiber cables, and the security of national long-distance dedicated optical fiber cables. The submarine optical fiber cables and the dedicated optical fiber cables usually cover a very long distance, and thus when intrusion occurs, alarm and positioning cannot be made timely. How to quickly and accurately implement the anti-theft measures for the ultra-long-distance optical fiber line is a complicated project.

At present, the conventional optical fiber vibration positioning and anti-theft technology can be applied to a length no more than 200 km and generally requires the occupancy of two fiber channels, which is an unnecessary waste for ultra-long-distance submarine optical fiber cables and dedicated optical fiber cables. In addition, the sensing distance of existing equipment can hardly reach the applicable distance of the submarine optical fiber cables.

The security of the submarine optical fiber cables and national long-distance dedicated optical fiber cables can be improved effectively, if there is an optical fiber vibration sensing positioning system provided for ultra-long-distance applications (with a distance greater than 1000 km) to save fiber channel resources and timely discover and locate an intrusion event.

### SUMMARY OF THE INVENTION

It is a primary objective of the invention to overcome the deficiencies of the prior art by providing a long-distance high-precision optical fiber interference sensing and positioning system in accordance with the present invention.

To achieve the aforementioned and other objectives, the present invention discloses a long-distance high-precision optical fiber interference sensing and positioning system, including: a sensing light path; a control terminal; a light source module, for outputting a front-end optical signal; a front-end optical processing module, for processing the front-end optical signal outputted by the light source module to generate an interference light signal; a back-end optical processing module, for processing the interference light signal transmitted from the sensing light path, modulating the interference light signal into a back-end optical signal, and then transmitting the back-end optical signal to the front-end optical processing module through the sensing light path; a photoelectric conversion module, for converting an optical signal into a digital signal; a digital signal collection module, for collecting and transmitting the photoelectrically converted digital signal to the control terminal; and a MCU central processing module, for controlling the light source module, the photoelectric conversion module and the digital signal collection module; wherein, the control terminal is installed with a signal processing and positioning device for calculating and positioning a sensing signal positioning information; the front-end optical processing module is connected to the back-end optical processing module through the sensing light path, and the photoelectric conversion module is connected to the front-end optical processing module and the digital signal collection module separately, and the digital signal collection module is connected to the control terminal.

Wherein, the sensing light path includes at least ten sequentially connected 100 km optical fiber modules, and each 100 km optical fiber module is connected to an optical amplifier module, and the long-distance high-precision optical fiber interference sensing and positioning system further includes an optical amplifier control module connected to the optical amplifier control module.

Wherein, the front-end optical processing module includes a FOIS optical processing unit, and the FOIS optical processing unit is of a white light interference processing technology.

Wherein, the optical amplifier module includes an erbium doped fiber amplifier (EDFA) with a bidirectional amplification function, and both light input and output ends of the erbium doped fiber amplifier (EDFA) are connected with an optical filter.

Wherein, the back-end optical processing module includes a Faraday rotator mirror and a 20 km single mode fiber.

Wherein, the photoelectric conversion module includes a PINFET, an ADC and low noise broadband amplifier which are sequentially connected to one another

Wherein, the light source module includes a super luminescent diode, an optical filter, a thermistor and a cooler, and the light source module is for controlling a super luminescent diode, ensuring the super luminescent diode is working in a normal state, and the light source module further includes an unidirectional magnification polarization maintaining erbium doped fiber amplifier (EDFA-PM) of an optical bandpass filter.

Wherein, the MCU central processing module is an AMR central processing unit.

The present invention has the following advantageous effects: the present invention can solve the security problem of an ultra-long-distance optical fiber cable, can send alarm information in a timely manner with regard to an intrusion event by means of vibration positioning, and can also solve the problem of occupation of an optical cable channel to improve the utilization efficiency of the optical cable by means of wavelength division multiplexing technology.

### BRIEF DESCRIPTION OF THE DRAWINGS

FIG. 1 is a block diagram of a long-distance high-precision optical fiber interference sensing and positioning system of this invention.

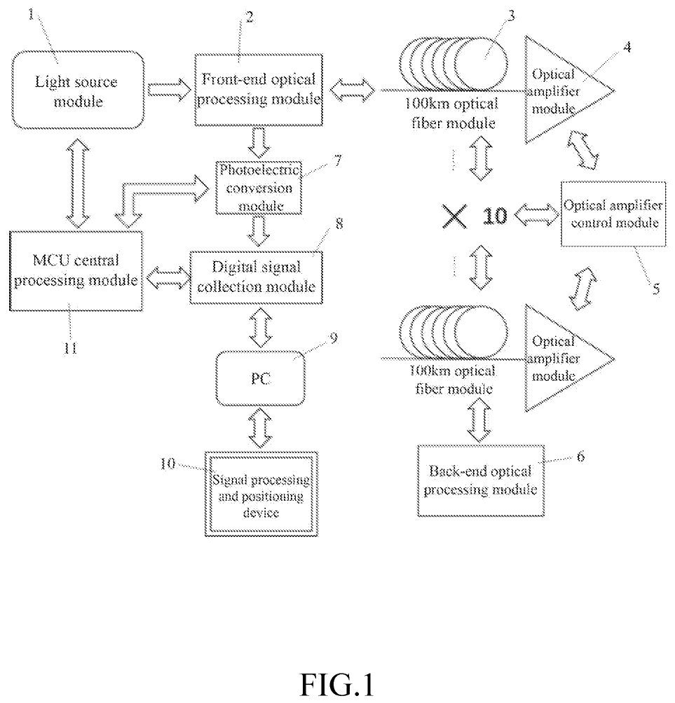

### BRIEF DESCRIPTION OF NUMERALS USED IN THE DRAWINGS

1: Light source module; 2: Front-end optical processing module; 3: 100 km optical fiber module; 4: Optical amplifier module; 5: Optical amplifier control module; 6: Back-end optical processing module; 7: Photoelectric conversion module; 8: Digital signal collection module; 9: Control terminal; 10: Signal processing and positioning device; 11: MCU central processing module.

### DESCRIPTION OF THE PREFERRED EMBODIMENTS

This invention will become clearer in light of the following detailed description of an illustrative embodiment of this invention described in connection with the drawings. It is intended that the embodiments and FIGURES disclosed herein are to be considered illustrative rather than restrictive.

The present invention discloses a long-distance high-precision optical fiber interference sensing and positioning system, including: a sensing light path; a control terminal; a light source module, for outputting a front-end optical signal; a front-end optical processing module, for processing the front-end optical signal outputted by the light source module to generate an interference light signal; a back-end optical processing module, for processing the interference light signal transmitted from the sensing light path, modulating the interference light signal into a back-end optical signal, and then transmitting the back-end optical signal to the front-end optical processing module through the sensing light path; a photoelectric conversion module, for converting an optical signal into a digital signal; a digital signal collection module, for collecting and transmitting the photoelectrically converted digital signal to the control terminal; and a MCU central processing module, for controlling the light source module, the photoelectric conversion module and the digital signal collection module; wherein the control terminal is installed with a signal processing and positioning device for calculating and positioning a sensing signal positioning information, and the front-end optical processing module is connected to the back-end optical processing module through the sensing light path, and the photoelectric conversion module is connected to the front-end optical processing module and the digital signal collection module separately, and the digital signal collection module is connected to the control terminal.

The sensing light path includes at least ten sequentially connected 100 km optical fiber modules, and each 100 km optical fiber module is connected to an optical amplifier module, and the long-distance high-precision optical fiber interference sensing and positioning system further includes an optical amplifier control module connected to the optical amplifier control module. The erbium doped fiber amplifier (EDFA) is connected between two adjacent 100 km optical fiber modules.

In the long-distance high-precision optical fiber interference sensing and positioning system of this embodiment, the optical amplifier module includes an erbium doped fiber amplifier (EDFA) with a bidirectional amplification function, and both light input and output ends of the erbium doped fiber amplifier (EDFA) are connected with an optical filter. Specifically, the erbium doped fiber amplifier (EDFA) has the wavelength division multiplexing feature that improves the utilization efficiency of the optical fiber cable.

In the long-distance high-precision optical fiber interference sensing and positioning system of this embodiment, the front-end optical processing module includes a FOIS optical processing unit, and the FOIS optical processing unit incorporates a white light interface processing technology.

In the long-distance high-precision optical fiber interference sensing and positioning system of this embodiment, the back-end optical processing module includes a Faraday rotator mirror and a 20 km single mode fiber.

In the long-distance high-precision optical fiber interference sensing and positioning system of this embodiment, the photoelectric conversion module includes a PINFET, an ADC and a low noise broadband amplifier which are sequentially connected to one another. Specifically, the PINFET is connected to the front-end optical processing module, and the low noise broadband amplifier is connected to the digital signal collection module.

In the long-distance high-precision optical fiber interference sensing and positioning system of this embodiment, the light source module includes a super luminescent diode, an optical filter, thermistor and a cooler, and the light source module is provided for controlling the super luminescent diode, and ensuring the super luminescent diode is working in a normal state, and the light source module further includes an unidirectional magnification polarization maintaining erbium doped fiber amplifier (EDFA-PM) of an optical bandpass filter optical bandpass filter.

In the long-distance high-precision optical fiber interference sensing and positioning system of this embodiment, the MCU central processing module is an AMR central processing unit.

Specifically, the light source module of the present invention is situated in a continuous lighting mode, and the MCU central processing module can be used to adjust the light intensity of the light source module, so that the signal complies with the working conditions of the light source module, and the light outputted by the light source module can enter into the front-end optical processing module to generate an interference light signal which can be used for sensing the signal entering into the sensing light path. After the interference light signal entering into the sensing light path, the interference light signal will go through a plurality of multi-stage optical amplifier module containing the erbium doped fiber amplifier (EDFA) for a relay compensation to prevent the sensing interference light signal from being annihilated by the noise due to the loss on the optical fiber lines.

After passing through the optical fiber module with a length over 1000 km, the interference light signal enters into the back-end optical processing module to modulate the interference signal, and the optical signal is reflected back to the light path by a Faraday rotator mirror, and relayed and amplified by the plurality of optical amplifier modules and then returned into the front-end optical processing module. After returning to the front-end optical processing module, the sensing optical signal enters into the photoelectric conversion module, and the photoelectric conversion module converts the optical signal and the sensing signal into electrical signals, and the electrical signals are converted into digital signals by the digital signal collection module and transmitted to the control terminal, wherein the control terminal can be a personal computer (PC) terminal. The digital signal enters into the signal processing and positioning device of the control terminal for processing and calculation for the sensing signal positioning, and the positioning information will be displayed on the signal processing and positioning device of the PC terminal.

In the confirmation of the positioning information of a vibration point, when a vibration shows up in the sensing line, there will be a change of light phase of the vibration location, and the phase change at the location will be shown by the change of light intensity. When the phase change information of the interfered light path and vibration signal is transmitted back to the photoelectric conversion module, a time delay will occur due to the distance of the optical path, so that the positioning information can be obtained by the calculating the time delay by the signal processing and positioning device, and the signal processing and positioning device can calculate the collected digital signal by means of a time delay algorithm in order to obtain the vibration positioning distance.

Where there is no external disturbance signal, the sensing path of the interference light signal is from the light source module→the front-end optical processing module→the (100 km optical fiber→the optical amplifier module) *10→the back-end optical processing module→the (100 km optical fiber→the optical amplifier module)*10→the front-end optical processing module→the photoelectric conversion module→the digital signal collection module→the control terminal→the signal processing and positioning device.

When an external vibration occurs, there are two paths of the interference signals passing through the sensing optical fiber (the front-end optical processing module→the back-end optical processing module, and the back-end optical processing module→the front-end optical processing module), so that after the occurrence of the vibration, the occurrence position of the vibration signal will be different, thereby resulting in a peak value other than the main peak value of the interference signal, and the peak value can be used to determine the distance.

It is noteworthy that the foregoing preferred embodiment is provided for describing and illustrating the technical characteristic of the present invention only, but not intended for limiting the present invention in any form. Although the present invention is disclosed by the preferred embodiment above, the embodiment does not limit the scope of the invention, and modifications and variations could be made to the embodiment by any person having ordinary skill in the art without departing from the scope and spirit of the invention set forth in the claims.

What is claimed is:

1. A long-distance high-precision optical fiber interference sensing and positioning system, comprising: a sensing light path;
a control terminal;
a light source module, for outputting a front-end optical signal;
a front-end optical processing module, for processing the front-end optical signal outputted by the light source module to generate an interference light signal;
a back-end optical processing module, for processing the interference light signal transmitted from the sensing light path, modulating the interference light signal into a back-end optical signal, and then transmitting the back-end optical signal to the front-end optical processing module through the sensing light path;
a photoelectric conversion module, for converting an optical signal into a digital signal;
a digital signal collection module, for collecting and transmitting the photoelectrically converted digital signal to the control terminal; and
a MCU central processing module, for controlling the light source module, the photoelectric conversion module and the digital signal collection module;
wherein, the control terminal is installed with a signal processing and positioning device for calculating and positioning a sensing signal positioning information; and
the front-end optical processing module is coupled to the back-end optical processing module through the sensing light path, and the photoelectric conversion module is coupled to the front-end optical processing module and the digital signal collection module separately, and the digital signal collection module is coupled to the control terminal.

2. The long-distance high-precision optical fiber interference sensing and positioning system according to claim 1, wherein the sensing light path comprises at least ten sequentially coupled 100 km optical fiber modules, and each 100 km optical fiber module is coupled to an optical amplifier module, and the long-distance high-precision optical fiber interference sensing and positioning system further comprises an optical amplifier control module coupled to the optical amplifier control module.

3. The long-distance high-precision optical fiber interference sensing and positioning system according to claim 1, wherein the front-end optical processing module comprises a FOIS optical processing unit, and the FOIS optical processing unit incorporates a white light interference processing technology.

4. The long-distance high-precision optical fiber interference sensing and positioning system according to claim 2, wherein the optical amplifier module comprises an erbium doped fiber amplifier (EDFA) with a bidirectional amplification function, and both light input and output ends of the erbium doped fiber amplifier (EDFA) are coupled with an optical filter.

5. The long-distance high-precision optical fiber interference sensing and positioning system according to claim 1, wherein the back-end optical processing module comprises a Faraday rotator mirror and a 20 km single mode fiber.

6. The long-distance high-precision optical fiber interference sensing and positioning system according to claim 1, wherein the photoelectric conversion module comprises a PINFET, an ADC and a low noise broadband amplifier which are sequentially coupled to one another.

7. The long-distance high-precision optical fiber interference sensing and positioning system according to claim 1, wherein the light source module comprises a super luminescent diode, an optical filter, a thermistor and a cooler, and the light source module is for controlling a super luminescent diode, ensuring the super luminescent diode is working in a normal state, and the light source module further comprises an unidirectional magnification polarization maintaining erbium doped fiber amplifier (EDFA-PM) of an optical bandpass filter.

8. The long-distance high-precision optical fiber interference sensing and positioning system according to claim 1, wherein the MCU central processing module is an AMR central processing unit.
